(19) United States
(12) Patent Application Publication
(10) Pub. No.: US 2010/0188591 A1
(43) Pub. Date: Jul. 29, 2010

(54) ELECTRO-OPTICAL DEVICE AND ELECTRONIC APPARATUS

(75) Inventor: Hiroyuki OIKAWA, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/692,337

(22) Filed: Jan. 22, 2010

(30) Foreign Application Priority Data
Jan. 23, 2009 (JP) 2009-012679
Nov. 19, 2009 (JP) 2009-263650

(51) Int. Cl. G02F 1/1343; G02F 1/03

(52) U.S. Cl. 349/39; 359/259

(57) ABSTRACT

Provided is an electro-optical device including: a plurality of pixel electrodes arranged in a pixel region; a lower electrode disposed at a lower layer side of the plurality of pixel electrodes with a dielectric film interposed therebetween so as to at least partially overlap the plurality of pixel electrodes in plan view; and a step difference reduction film disposed on an underlying surface of the lower electrode and formed in at least a portion of a lower electrode non-forming region of the pixel region so as to reduce a step difference between the upper surfaces of the lower electrode and the underlying surface in the lower electrode non-forming region.

### BACKGROUND

1. Technical Field

The present invention relates to a technical field of an electro-optical device such as a liquid crystal device and an electronic apparatus such as a liquid crystal projector including the electro-optical device.

2. Related Art

A liquid crystal device which is a kind of electro-optical device is configured by interposing liquid crystal, which is an example of an electro-optical material, between a pair of substrates. On one of the pair of substrates, a lamination structure formed of pixel switching Thin Film Transistors (TFTs) or lines such as scanning lines or data lines is formed, and a plurality of pixel electrodes is provided at an uppermost layer side of the lamination structure in a matrix. In such an electro-optical device, for the purpose of high contrast of a display image, storage capacitors may be provided between the pixel switching TFTs and the pixel electrodes. For example, JP-A-6-148684 discloses a technique of forming storage capacitors by forming capacitive electrodes so as to face pixel electrodes with a capacitive insulating film interposed therebetween.

In such an electro-optical device, an alignment film for regulating an alignment state of an electro-optical material is formed at an upper layer side of the pixel electrodes. If a step difference is present in a surface of an underlying layer of the alignment film, smoothness of the shape of the surface of the alignment film is disturbed and alignment failure of the electro-optical material occurs. JP-A-2008-39892 discloses a technique of improving alignment failure by forming a concave-convex pattern on a surface of an underlying layer of an alignment film in a direction perpendicular to an alignment direction of liquid crystal.

If the storage capacitors are provided in the lamination structure in order to achieve high quality of a display image, the capacitive value of each of the storage capacitors needs to be optimized. Optimization may be performed, for example, by changing the area of the electrode of each of the storage capacitors and adjusting the capacitive value. In this case, since the electrode of each of the storage capacitors is patterned, a region in which the electrode is formed and a region in which the electrode is not formed are inevitably generated on a substrate, when viewed on the plane of the substrate. To this end, a step difference is generated between the surface of the electrode and the surface of the underlying layer of the electrode, and, if the pixel electrode is formed on such a step difference, a step difference is also generated in the surface of the pixel electrode which is the underlying layer of the alignment film. When the concave-convex pattern is formed in the underlying layer of the pixel electrode as in JP-A-2008-39892, since the shape of the concave-convex pattern depends on the kind of the electro-optical material and the shape of the step difference present in the surface of the underlying film, the shape of the concave-convex pattern may become complicated according to the configuration condition on the substrate. In particular, in a liquid crystal device in which the pixel pitch is decreased under a requirement for high definition, it is difficult to uniformly form a concave-convex pattern over an entire image display region with high accuracy, from a technical point of view.

### SUMMARY

An advantage of some aspects of the invention is that it provides an electro-optical device capable of achieving a high-quality image display while suppressing alignment failure of an electro-optical material, and an electronic apparatus including the electro-optical device.

According to an aspect of the invention, there is provided a first electro-optical device including, on a substrate: a plurality of pixel electrodes arranged in a pixel region; a lower electrode disposed at a lower layer side of the plurality of pixel electrodes with a dielectric film interposed therebetween and formed on the substrate so as to at least partially overlap the plurality of pixel electrodes in plan view; and a step difference reduction film disposed on an underlying surface of the lower electrode and formed in at least a portion of a lower electrode non-forming region excluding a lower electrode forming region, in which the lower electrode is formed, of the pixel region so as to reduce a step difference between the upper surface of the lower electrode and the underlying surface in the lower electrode non-forming region.

In the first electro-optical device of the invention, for example, lines such as scanning lines or data lines and electronic elements such as pixel switching transistors are laminated on the substrate with an insulating film interposed therebetween as necessary while being insulated from each other so as to configure circuits for driving the pixel electrodes, and the pixel electrodes are disposed at the upper layer side thereof. During the operation of the electro-optical device, for example, the switching operations of the pixel switching TFTs electrically connected to the pixel electrodes are controlled by the scanning lines, and image signals are supplied via the data lines such that voltages according to the image signals are applied to the pixel electrodes via the TFTs. Accordingly, an image display of a pixel region or a pixel array region (also called “image display region”) in which the plurality of pixel electrodes is arranged is possible.

The lower electrode is disposed at the lower layer side of the plurality of pixel electrodes with a dielectric film interposed therebetween. That is, by inserting the dielectric film between the lower electrode and the pixel electrodes, storage capacitors electrically connected to the pixel electrodes are formed. By forming the storage capacitors in the lamination structure, it is possible to hold a voltage signal corresponding to a display image in a predetermined period, which is applied to the pixel electrodes, and to improve the quality of the display image of the electro-optical device.

The lower electrode is formed on the substrate so as to at least partially overlap the plurality of pixel electrodes in plan view. That is, the lower electrode of the invention is patterned in a predetermined shape according to capacitive values of the storage capacitors to be formed. That is, by adjusting the area on the substrate by patterning, the capacitive values of the storage capacitors are adjusted. In addition, the lower electrode may have various shapes if the lower electrode is formed on the substrate so as to at least partially overlap the plurality of pixel electrodes in plan view. For example, the lower electrode may be solidly formed over the entire pixel region and openings may be formed such that a predetermined region is opened in each pixel (that is, a hole is formed in each pixel). The lower electrode may be formed in an island shape in each pixel similar to the pixel electrodes and have a partially notched portion.

In the lower electrode, when viewed on the substrate in plan view, the pixel region includes a region in which the lower electrode is formed (that is, a lower electrode forming region) and a region in which the lower electrode is not formed in the pixel region (that is, a lower electrode non-forming region).

Here, with respect to the underlying surface of the lower electrode, the step difference is generated between the surface of the lower electrode in the lower electrode forming region and the underlying surface of the lower electrode non-forming region. If the interlayer insulating film is solidly formed on the step difference and the pixel electrodes are formed thereon, the step difference corresponding thereto is formed even in the surface of the pixel electrodes. Then, the distribution of the electric field in the vicinities of the surfaces of the pixel electrodes are disturbed and failure occurs in the alignment state of the electro-optical material. In addition, since the smoothness of the surfaces of the pixel electrodes is damaged, risk that alignment failure of the electro-optical material occurs is increased. Therefore, the electro-optical device of the invention includes the following step difference reduction film in order to reduce such risk.

The step difference reduction film is disposed on the underlying surface of the lower electrode and is formed in at least the portion of the lower electrode non-forming region excluding the lower electrode forming region so as to reduce the step difference between the upper surface of the lower electrode and the underlying surface of the lower electrode non-forming region. In other words, the step difference reduction film is formed so as to embed the step difference generated between the surface of the lower electrode in the lower electrode forming region and the underlying surface in the lower electrode non-forming region, in order to reduce the above risk. Accordingly, typically, the step difference reduction film is formed on the underlying surface as the same layer as the lower electrode. By providing the step difference reduction film, since the step difference between the upper surface of the lower electrode and the underlying surface in the lower electrode non-forming region is solved, the step difference is not generated in the surfaces of the pixel electrodes formed at the upper layer side of the lower electrode. As a result, since the smoothness of the surfaces of the pixel electrodes is not damaged and the distribution of the electric field in the vicinities of the surfaces of the pixel electrodes are not disturbed, it is possible to efficiently prevent alignment failure of the electro-optical material.

In addition, the step difference reduction film may be formed in at least the portion of the lower electrode non-forming region. That is, if the step difference reduction film is formed in a recess of the lower electrode, since the step difference in the surface of the pixel electrodes or the alignment film can be remarkably reduced, the above-described merits can be obtained.

As described above, according to the first electro-optical device of the invention, by forming the step difference reduction film, it is possible to suppress or prevent the step difference from being generated in the pixel electrodes and the alignment film. As a result, it is possible to efficiently prevent alignment failure of the electro-optical material such as liquid crystal and to realize an electro-optical device capable of displaying a high-quality image.

In the electro-optical device of the invention, the upper surfaces of the lower electrode and the step difference reduction film may be flush with each other.

According to this aspect, the step difference reduction film is formed such that the upper surfaces of the lower electrode and the step difference reduction film are flush with each other, in order to more efficiently solve the step difference between the surface of the lower electrode in the lower electrode forming region and the underlying surface in the lower electrode non-forming region. That is, ideally, the upper surfaces of the lower electrode and the step difference reduction film may be equal or substantially equal, or may be at least equal or substantially equal.

In the electro-optical device of the invention, the upper surfaces of the lower electrode and the step difference reduction film may be subjected to a planarization process for reducing the step difference therebetween.

By such configuration, the step difference between the surface of the lower electrode in the lower electrode forming region and the underlying surface in the lower electrode non-forming region can be reduced by the planarization process. In addition, as the planarization process, for example, a Chemical Mechanical Polishing (CMP) process may be performed or a process of forming the lower electrode and the step difference reduction film with proper film thicknesses and performing an etching process with respect to the lower electrode and the step difference reduction film.

In the electro-optical device of the invention, the plurality of pixel electrodes and the lower electrode may be formed of a transparent conductive material.

According to this aspect, since the pixel electrodes and the lower electrode are formed of a transparent conductive material such as Indium Tin Oxide (ITO), an opened region of each pixel (that is, for example, a region in which light contributing to a display in each pixel is emitted) may not be small.

According to a second aspect of the invention, a second electro-optical device including: transistors; pixel electrodes provided in correspondence with the transistors; a lower electrode disposed on a layer between the transistors and the pixel electrodes and facing the pixel electrodes with a dielectric film interposed therebetween so as to form storage capacitors; a first relay layer disposed on the same layer as the lower electrode on the inside of an opening of the lower electrode and electrically connecting the transistors and the pixel electrodes; and a step difference reduction film disposed between the lower electrode and the first relay layer in plan view.

In the second electro-optical device of the invention, for example, lines such as scanning lines or data lines and electronic elements such as pixel switching transistors are laminated on the substrate with an insulating film interposed therebetween as necessary while being insulated from each other so as to configure circuits for driving the pixel electrodes, and the pixel electrodes are disposed at the upper layer side thereof. During the operation of the electro-optical device, for example, the switching operations of the pixel switching TFTs electrically connected to the pixel electrodes are controlled by the scanning lines, and image signals are supplied via the data lines such that voltages according to the image signals are applied to the pixel electrodes via the TFTs. Accordingly, an image display of a pixel region or a pixel array region (also called “image display region”) in which the plurality of pixel electrodes is arranged is possible.

The lower electrode is disposed at the lower layer side of the plurality of pixel electrodes with a dielectric film interposed therebetween. That is, by inserting the dielectric film between the lower electrode and the pixel electrodes, storage capacitors electrically connected to the pixel electrodes are formed. By forming the storage capacitors in the lamination structure, it is possible to hold a voltage signal corresponding to a display image and to improve the quality of the display image of the electro-optical device.

The lower electrode is formed on the substrate so as to at least partially overlap the plurality of pixel electrodes in plan view. That is, the lower electrode of the invention is patterned in a predetermined shape according to capacitive values of the storage capacitors to be formed. In detail, in the lower electrode, an opening is formed over two adjacent pixels such that a predetermined region is opened in each pixel (that is, a hole is formed in each pixel).

In the opening of the lower electrode, since the pixel electrodes and the lower electrode do not face each other with a dielectric film interposed therebetween, the storage capacitors are not formed. Accordingly, by adjusting the size of the opening of the lower electrode, it is possible to adjust the capacitive values of the storage capacitors. On the inside of the opening of the lower electrode, the first relay layer electrically connecting the transistors and the pixel electrodes is provided on the same layer as the lower electrode. In addition, the term “same layer” refers to a layer formed by the same film forming process as the lower electrode.

In order to form the above-described opening, when viewed on the substrate in plan view, the pixel region includes a region in which the lower electrode is formed (that is, a lower electrode forming region) and a region in which the lower electrode is not formed in the pixel region (that is, a lower electrode non-forming region). The lower electrode non-forming region includes a region in which the first relay layer is formed and a region in which the first relay layer is not formed.

Here, with respect to the underlying surface of the lower electrode, the step difference is generated between the surface of the lower electrode in the lower electrode forming region and the surface of the first relay layer in the lower electrode non-forming region. If the capacitive insulating film which is a dielectric film is solidly formed on the step difference and the pixel electrodes are formed thereon, the step difference corresponding thereto is formed even in the surface of the pixel electrodes. Then, the distribution of the electric field in the vicinities of the surfaces of the pixel electrodes are disturbed and failure occurs in the alignment state of the electro-optical material. In addition, since the smoothness of the surfaces of the pixel electrodes is damaged, risk that alignment failure of the electro-optical material occurs is increased. Therefore, the electro-optical device of the invention includes the following step difference reduction film in order to reduce such risk.

The step difference reduction film is disposed on the underlying surface of the lower electrode and is formed in at least the portion of the lower electrode non-forming region excluding the lower electrode forming region, for example, between the lower electrode and the first relay layer in plan view so as to reduce the step difference between the upper surface of the lower electrode or the first relay layer and the underlying surface of the lower electrode non-forming region. In other words, the step difference reduction film is formed so as to embed the step difference generated between the surface of the lower electrode in the lower electrode forming region and the underlying surface in the lower electrode non-forming region, in order to reduce above risk. Accordingly, typically, the step difference reduction film is formed on the underlying surface as the same layer as the lower electrode. By providing the step difference reduction film, since the step difference between the upper surface of the lower electrode and the underlying surface in the lower electrode non-forming region is solved, the step difference is not generated in the surfaces of the pixel electrodes formed at the upper layer side of the lower electrode. As a result, since the smoothness of the surfaces of the pixel electrodes is not damaged and the distribution of the electric field in the vicinities of the surfaces of the pixel electrodes are not disturbed, it is possible to efficiently prevent alignment failure of the electro-optical material.

In addition, the step difference reduction film may be formed in at least the portion of the lower electrode non-forming region. That is, if the step difference reduction film is formed in a recess of the lower electrode, since the step difference in the surface of the pixel electrodes or the alignment film can be remarkably reduced, the above-described merits can be obtained.

As described above, according to the first electro-optical device of the invention, by forming the step difference reduction film, it is possible to suppress or prevent the step difference from being generated in the pixel electrodes and the alignment film. As a result, it is possible to efficiently prevent alignment failure of the electro-optical material such as liquid crystal and to realize an electro-optical device capable of displaying a high-quality image.

In the electro-optical device of the invention, the pixel electrodes, the lower electrode and the first relay layer may be formed of a transparent conductive material.

Since the pixel electrodes and the lower electrode are formed of a transparent conductive material such as Indium Tin Oxide (ITO), a region in which light contributing to a display in each pixel is emitted may not be small.

The electro-optical device of the invention may include data lines disposed on a layer between the transistors and the lower electrode and electrically connected to the transistors, and a second relay layer disposed on the same layer as the data lines and electrically connecting the transistors and the pixel electrodes, and the first relay layer and the second relay layer may be electrically connected via contact holes provided in the openings in plan view.

According to this aspect, the transistors and the pixel electrodes are electrically connected via at least the first relay layer and the second relay layer. The second relay layer is disposed on the same layer as the data lines. Accordingly, the pixel electrodes and the transistors can be electrically connected with certainty.

In the electro-optical device of the invention, the first relay layer may be long in a length of a direction in which the data lines extend from the second relay layer.

According to this aspect, since the second relay layer disposed on the same layer as the data lines is formed within the pixel so as to be smaller than that of the first relay layer. Since the second relay layer is formed of a metal material similar to the data lines, a region which does not contribute to a display is formed in the pixel. The second relay layer is disposed so as to be housed in a region overlapping the scanning lines and the first transparent relay layer is provided so as to protrude toward the pixel electrodes rather than the second relay layer such that the pixel electrodes and the transistors are electrically connected with certainty, without narrowing the region contributing the display.

In the electro-optical device of the invention, the surfaces of the lower electrode, the first relay layer and the step difference reduction film may be smoothly flush with one another.

By this configuration, since the underlying layer on which the pixel electrodes are formed is flat, it is possible to efficiently prevent disturbance of the distribution of the electric field in the vicinities of the surfaces of the pixel electrodes due to a concave-convex pattern of the pixel electrodes or the alignment failure of the electro-optical material.

According to another aspect of the invention, there is provided an electronic apparatus including the electro-optical device (including various aspects).

Since the electronic apparatus of the invention includes the electro-optical device of the invention, it is possible to realize various electronic apparatuses such as a projective display device, a television set, a cellular phone, an electronic organizer, a word processor, a viewfinder-type or direct-view monitor type video tape recorder, a workstation, a videophone, a POS terminal, and a touch-panel-equipped device, which are capable of performing a high-quality image display. As the electronic apparatus of the invention, for example, it is possible to realize an electrophoretic apparatus such as an electronic paper, an electron emission apparatus (Field Emission display and Conduction Electron-Emitter Display), and a display device using the electrophoretic apparatus and the electron emission apparatus.

The operation and the other advantages of the invention will be apparent from the following best mode.

### BRIEF DESCRIPTION OF THE DRAWINGS

The invention will be described with reference to the accompanying drawings, wherein like numbers reference like elements.

FIG. 1 is a plan view showing the overall configuration of a liquid crystal device according to the present embodiment.

FIG. 2 is a cross-sectional view taken along line II-II of FIG. 1.

FIG. 3 is a circuit diagram showing the electrical configuration of the liquid crystal device according to the present embodiment.

FIG. 4 is a schematic view projectively showing a positional relationship among lines of an image display region 10a of the liquid crystal device according to the invention.

FIG. 5 is a cross-sectional view taken along line V-V of FIG. 4.

FIG. 6 is a schematic view projectively showing a positional relationship of capacitive electrodes on a substrate of the liquid crystal device according to the present embodiment along with peripheral lines.

FIG. 7 is a cross-sectional view of the same purpose of FIG. 5 in a liquid crystal device of a comparative example.

FIGS. 8A and 8B are cross-sectional views showing electric fields between substrates in the image display region, in the liquid crystal devices according to the present embodiment and the comparative example.

FIG. 9A to 9D are cross-sectional views showing processes of a method of manufacturing a lamination structure on a TFT array substrate of the liquid crystal device according to the present embodiment.

FIG. 10 is a (first) plan view projectively showing a positional relationship between layers configuring a liquid crystal device according to a second embodiment.

FIG. 11 is a (second) plan view projectively showing a positional relationship between layers configuring the liquid crystal device according to the second embodiment.

FIG. 12 is a cross-sectional view showing a lamination structure of the liquid crystal device according to the second embodiment.

FIG. 13 is an example of an electronic apparatus to which the electro-optical device according to the present embodiment is applied.

### DESCRIPTION OF EXEMPLARY EMBODIMENTS

Hereinafter, the embodiments of the invention will be described with reference to the accompanying drawings. In the following embodiments, a TFT active matrix driving type liquid crystal device, in which a driving circuit is mounted, will be described as an example of an electro-optical device of the invention.

### Liquid Crystal Device

### First Embodiment

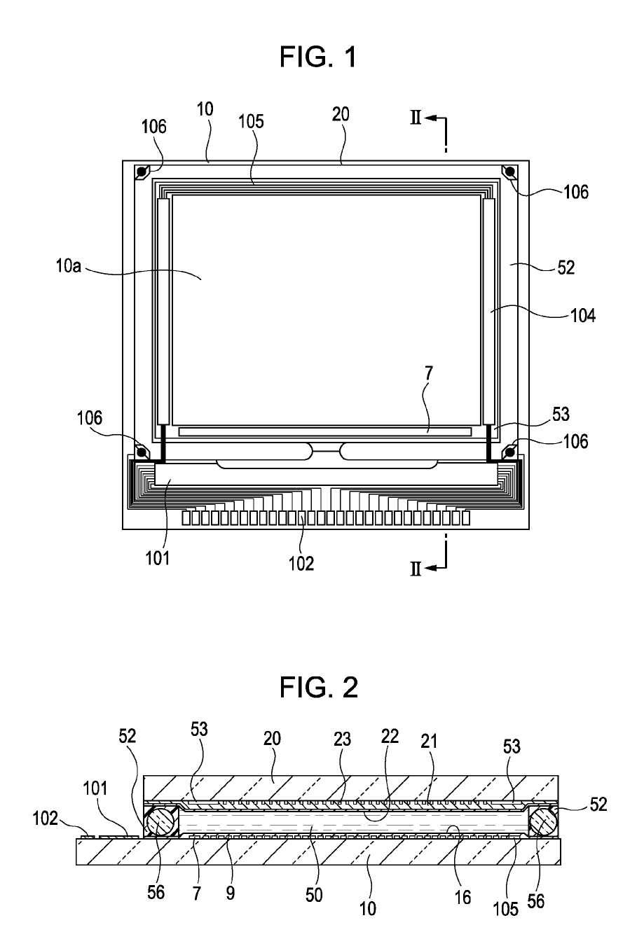

First, the entire configuration of the liquid crystal device according to the present embodiment will be described with reference to FIGS. 1 and 2.

FIG. 1 is a schematic plan view showing the configuration of a liquid crystal device when a TFT array substrate 10 is viewed from the side of a counter substrate 20 together with components formed thereon, and FIG. 2 is a cross-sectional view taken along line II-II of FIG. 1.

In FIGS. 1 and 2, the liquid crystal device according to the present embodiment includes the TFT array substrate 10 and the counter substrate 20 which face each other. The TFT array substrate 10 is, for example, a transparent substrate such as a quartz substrate or a glass substrate or a silicon substrate. The counter substrate 20 is, for example, a transparent substrate such as a quartz substrate or a glass substrate. A liquid crystal layer 50 is filled between the TFT array substrate 10 and the counter substrate 20, and the TFT array substrate 10 and the counter substrate 20 are mutually adhered by a seal material 52 provided in a seal region located at the periphery of an image display region 10a in which an electro-optical operation is performed.

The seal material 52 is formed of, for example, an ultraviolet curing resin or a thermo-setting resin for mutually adhering both the substrates, and is applied on the TFT array substrate 10 and hardened by ultraviolet ray irradiation or heating in a manufacturing process. For example, gap materials 56, such as glass fibers or glass beads, for adjusting the gap between the TFT array substrate 10 and the counter substrate 20 (the gap between the substrates) to a predetermined value are dispersed in the seal material 52.

In parallel to the inside of the seal region in which the seal material 52 is disposed, a frame light-shielding film 53 which has a light-shielding property and defines a frame region of the image display region 10a is provided on the side of the counter substrate 20. A portion or the whole of the frame light-shielding film 53 may be provided on the side of the TFT array substrate 10 as a built-in light-shielding film.

In a peripheral region located at the periphery of the image display region 10a on the TFT array substrate 10, a data line driving circuit 101, a sampling circuit 7, scanning line driving circuits 104 and an external circuit connection terminal 102 are formed.

In the peripheral region on the TFT array substrate 10, a data line driving circuit 101 and a plurality of external circuit connection terminals 102 are provided along one side of the TFT array substrate 10 at the outer circumferential side of the seal region.

In a region located at the inside of the seal region in the peripheral region on the TFT array substrate 10, a sampling circuit 7 is disposed along one side of the image display region 10a disposed along one side of the TFT array substrate 10 so as to be covered by the frame light-shielding film 53.

In addition, the scanning line driving circuits 104 are provided along two sides adjacent to one side of the TFT array substrate 10 so as to be covered by the frame light-shielding film 53. In order to electrically connect two scanning line driving circuits 104 provided at both sides of the image display region 10a, a plurality of lines 105 is provided along one remaining side of the TFT array substrate 10 so as to be covered by the frame light-shielding film 53.

In the peripheral region on the TFT array substrate 10, vertical conductive terminals 106 are disposed in region facing four corner portions of the counter substrate 20, and vertical conductive materials are provided between the TFT array substrate 10 and the counter substrate 20 so as to be electrically connected to the terminals 106 in correspondence with the vertical conductive terminals 106.

In FIG. 2, a lamination structure formed of pixel switching TFTs or lines such as scanning lines or data lines is formed on the TFT array substrate 10. In the image display region 10a, pixel electrodes 9 are provided on an upper layer of the pixel switching TFTs or the lines such as the scanning lines or the data lines in a matrix. The pixel electrodes 9 are formed as transparent electrodes formed of an ITO film. An alignment film 16 is formed on the pixel electrodes 9.

A light-shielding film 23 is formed on a surface of the counter substrate 20 opposed to the TFT array substrate 10. The light-shielding film 23 is formed of, for example, a light-shielding metal film or the like and is patterned, for example, in a lattice shape or the like in the image display region 10a on the counter substrate 20. A counter electrode 21 formed of an ITO film is, for example, solidly formed on the light-shielding film 23 (on the lower side of the light-shielding film 23 in FIG. 2) so as to face the plurality of pixel electrodes 9, and an alignment film 22 is formed on the counter electrode 21 (on the lower side of the counter electrode 21 in FIG. 2).

The liquid crystal layer 50 is formed of, for example, liquid crystal obtained by mixing one type or several types of nematic liquid crystal and has a predetermined alignment state between a pair of alignment films. When driving the liquid crystal device, by applying a voltage, liquid crystal capacitance is formed between the pixel electrodes 9 and the counter electrode 21.

Although not shown herein, a precharge circuit for supplying a precharge signal having a predetermined voltage level to the plurality of data lines prior to image signals, an inspection circuit for inspecting the quality or defect of the liquid crystal device during manufacturing before shipment, or the like may be formed on the TFT array substrate 10, in addition to the data line driving circuit 101 and the scanning line driving circuits 104.

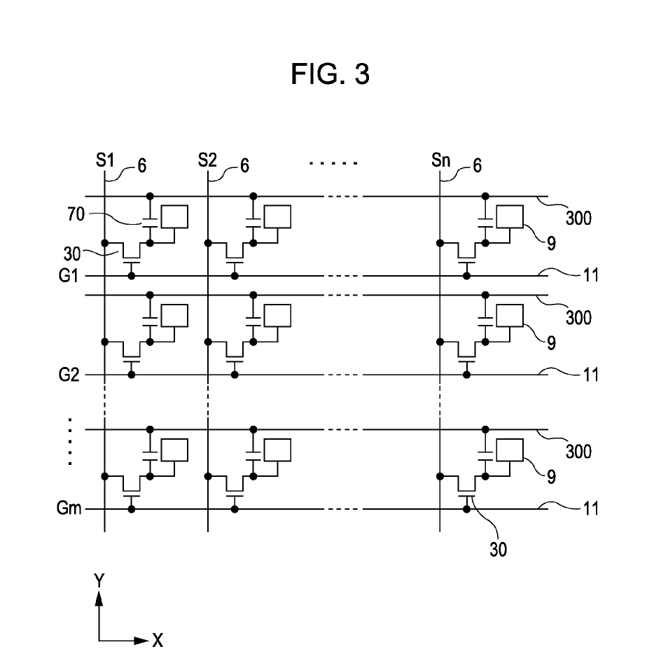

Next, the electrical configuration of the image display region of the liquid crystal device according to the present embodiment will be described with reference to FIG. 3. FIG. 3 is a circuit diagram showing various elements and lines of the plurality of pixels formed in a matrix configuring the image display region of the liquid crystal device according to the present embodiment.

In FIG. 3, the pixel electrodes 9 and the pixel switching TFTs 30 are respectively formed in the plurality of pixels formed in the matrix configuring the image display region 10a. The TFTs 30 are electrically connected to the pixel electrodes 9 and the switching of the pixel electrodes 9 is controlled when operating the liquid crystal device according to the present embodiment. The data lines 6 to which the image signals are supplied are electrically connected to source regions of the TFTs 30, respectively. The image signals S1, S2, . . . , and Sn written to the data lines 6 may be line-sequentially supplied in this order or may be supplied to a group of a plurality of alternately adjacent data lines 6.

The scanning lines 11 are electrically connected to gates of the TFTs 30, and, in the liquid crystal device according to the present embodiment, scanning signals G1, G2, . . . , and Gm are line-sequentially applied to the scanning lines 11 at predetermined timings in this order in a pulsed manner. The pixel electrodes 9 are electrically connected to drains of the TFTs 30, and the image signals S1, S2, . . . , and Sn supplied from the data lines 6 are written at predetermined timings, by switching off the TFTs 30, which are switching elements, during a predetermined period. The image signals S1, S2, . . . , and Sn having a predetermined level, which are written to the liquid crystal through the pixel electrodes 9, are maintained for a predetermined period with the counter electrode 21 (see FIG. 2) formed on the counter substrate 20 (see FIG. 2).

The liquid crystal configuring the liquid crystal layer 50 (see FIG. 2) modulates light and performs a gradation display by changing alignment or order of a set of molecules by the applied voltage level. In a normally white mode, transmissivity of incident light is decreased according to a voltage applied in the unit of pixels and, in a normally black mode, transmissivity of incident light is increased according to a voltage applied in the unit if pixels. As a whole, light having contrast according to the image signals is emitted from the liquid crystal device.

In order to prevent leakage of the image signals maintained herein, storage capacitors 70 are electrically added to liquid crystal capacitors formed between the pixel electrodes 9 and the counter electrode 21 in parallel (see FIG. 2). One electrode of each of the storage capacitors 70 is electrically connected to the drain of each of the TFTs 30 in parallel to each of the pixel electrodes 9 and the other electrode thereof is connected to each of capacitive lines 300 having a fixed potential so as to become a predetermined potential. For example, since the voltages of the pixel electrodes 9 are maintained by the storage capacitors 70 during a time longer than a time, in which a source voltage is applied, by three digits, as the result of improving the maintaining characteristics, a high contrast ratio is realized.

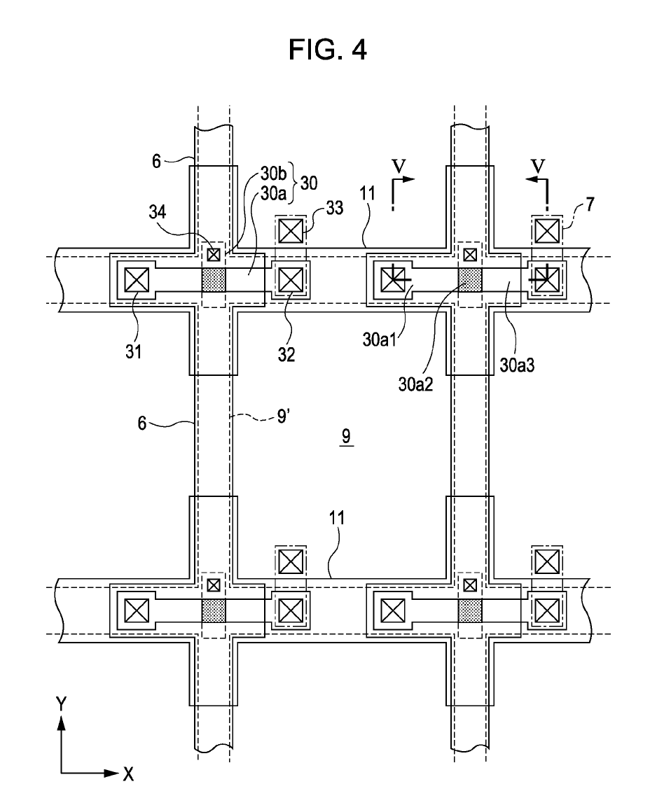

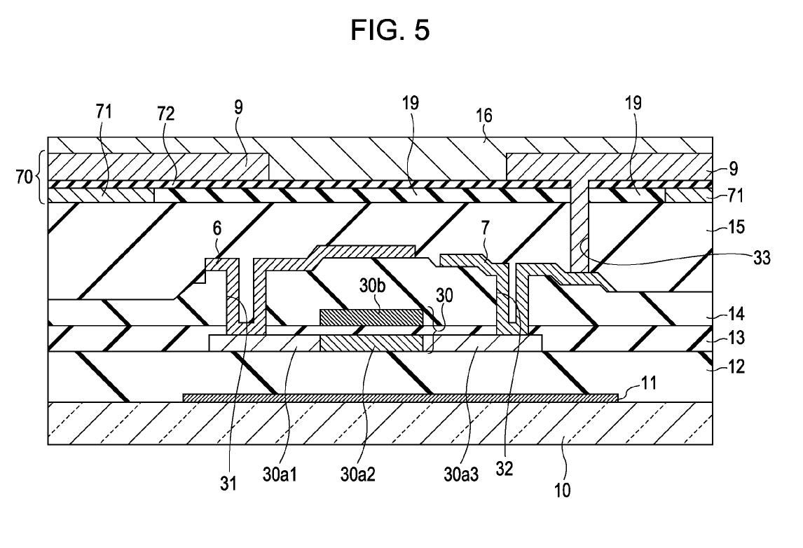

Next, the detailed lamination structure of the image display region 10a will be described in detail with reference to FIGS. 4 and 5.

FIG. 4 is a schematic view projectively showing a positional relationship among the scanning lines, the data lines, the pixel switching TFTs and a relay layer a of the liquid crystal device according to the invention. FIG. 5 is a cross-sectional view taken along line V-V of FIGS. 4 and 5. In FIGS. 4 and 5, the scale of each layer or each element is differentiated from each other in order that each layer or each element has a size capable of being identified in the view.

On the TFT array substrate 10, as shown in FIG. 4, the scanning lines 11 and the data lines 6 are respectively disposed along an X direction and a Y direction and the TFTs 30 are formed in the vicinities of the intersections between the data lines 6 and the scanning lines 11.

The scanning lines 11 are formed of a light-shielding conductive material, for example, tungsten (W), titanium (Ti), titanium nitride (TiN) or the like, and have a width greater than that of a semiconductor layer 30a so as to include the semiconductor layer 30a on the TFT array substrate 10 in plan view. Since the scanning lines 11 are disposed at a lower layer side of the semiconductor layer 30a, by widely forming the scanning lines 11 from the semiconductor layer 30a of the TFTs 30, it is possible to mostly or completely shield a channel region 30b of each of the TFTs 30 from return light such as light emitted from another liquid crystal device and penetrating a synthesis optical system by rear surface reflection of the TFT array substrate 10, a double plate type projector or the like. As a result, during the operation of the liquid crystal device, light leakage current of the TFTs 30 is reduced, a contrast ratio can be improved, and a high-quality image display is possible.

Each of the TFTs 30 has the semiconductor layer 30a and a gate electrode 30b. The semiconductor layer 30a includes a source region 30a1, a channel region 30a2 and a drain region 30a3. A Lightly Doped Drain (LDD) region may be formed between the channel region 30a2 and the source region 30a1 or between the channel region 30a2 and the drain region 30a3.

The gate electrode 30b is formed on the TFT array substrate 10 at an upper layer side of the semiconductor layer 30a in a region overlapping the channel region of the semiconductor layer 30a with a gate insulating film 13 interposed therebetween in plan view. The gate electrode 30b is formed of, for example, conductive polysilicon and is electrically connected to each of the scanning lines 11 disposed at the lower layer side thereof via a contact hole 34 (see FIG. 4).

The source region 30a1 of each of the TFTs 30 is electrically connected to each of the data lines 6 formed on a first interlayer insulating film 14 via a contact hole 31. Meanwhile, the drain region 30a3 is electrically connected to a relay layer 7 formed on the same layer as the data lines 6 via a contact hole 32. The relay layer 7 is electrically connected to the below-described pixel electrodes 9 via a contact hole 33. That is, the drain region 30a3 of each of the TFTs 30 and each of the pixel electrodes 9 are electrically relayed and connected by the relay layer 7.

The storage capacitors 70 are formed at an upper layer side of the data lines 6 and the relay layer 7 with a second interlayer insulating film 15. As described above, by electrically connecting the storage capacitors 70 to the liquid crystal capacitors in parallel, the voltage of the pixel electrodes 9 can be maintained during the time longer than the time, in which the image signals are actually applied, for example, by three digits, and thus the holding characteristics of a liquid crystal element is improved. Therefore, it is possible to realize a liquid crystal device having a high contrast ratio.

Capacitive electrodes 71 function as one electrode of the storage capacitors 70 electrically connected to the liquid crystal capacitors in parallel and are electrically connected to the capacitive lines 300 so as to be held at a fixed potential.

A capacitive insulating film 72 is formed on the capacitive electrodes 71. The capacitive insulating film 72 is solidly formed so as to cover the capacitive electrodes 71. In addition, since silicon nitride is a transparent dielectric material, even when the capacitive insulating film 72 is widely formed in the image display region 10a including an opened region, light transmissivity of the opened region does not substantially or practically deteriorate.

The pixel electrodes 9 are formed on the capacitive insulating film 72. As shown in FIG. 4, the pixel electrodes 9 are respectively formed in the pixels partitioned by the data lines 6 and the scanning lines 11 in a matrix in an island shape. In FIG. 4, the contours of the pixel electrodes 9 are shown by dotted lines 9′.

In the present embodiment, in particular, each of the pixel electrodes 9 has a function as one electrode of each of the storage capacitors 70, in addition to an original function for voltage-controlling the alignment state of the liquid crystal molecules configuring the liquid crystal layer 50. That is, by using the pixel electrodes 9 as the capacitive electrodes facing the capacitive electrodes 71, it is possible to simplify the lamination structure, as compared with the case where the capacitive electrodes facing the capacitive electrodes 71 are provided on the capacitive insulating film 72 on a layer different from the pixel electrodes 9 separately from the pixel electrodes 9. Accordingly, it is possible to obtain a merit that high definition of a pixel size is facilitated.

The alignment film 16 for regulating the alignment state of the liquid crystal molecules included in the liquid crystal layer 50 (see FIG. 2) is formed on the pixel electrodes 9.

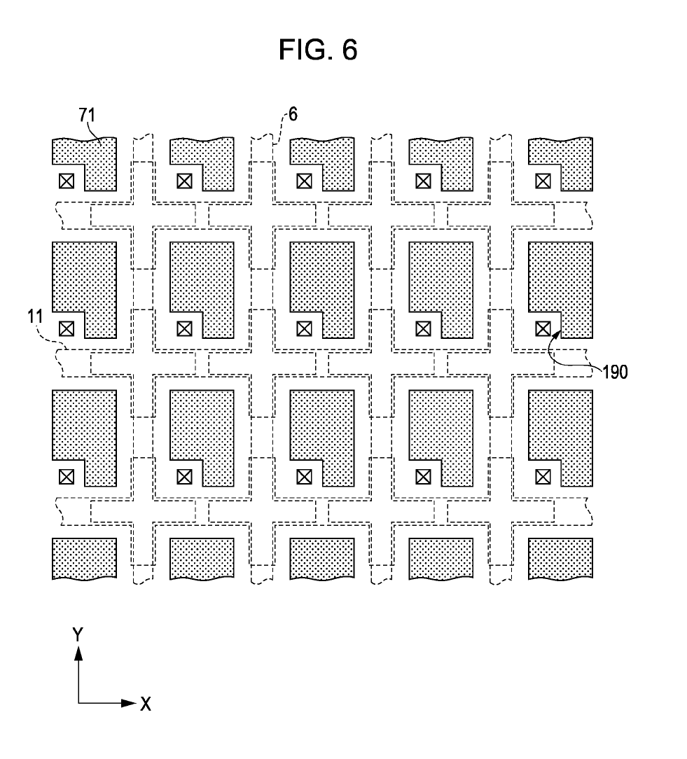

Now, the plane structure of the capacitive electrodes 71 will be described with reference to FIG. 6. FIG. 6 is a plan view showing the plane structure of the capacitive electrodes 71, and the scale of each layer or each element is differentiated from each other in order that each layer or each element has a size capable of being identified in the view.

The capacitive electrodes 71 are respectively formed in the pixels partitioned by the scanning lines 11 and the data lines 6 in an island shape. Conversely, the capacitive electrodes 71 are formed in regions close to the centers of the notched pixels and are not formed in the vicinities of the regions along the scanning lines 11 and the data lines 6. In addition, in order to form the contact hole 33 for relaying and connecting the pixel electrodes 9 and the relay layer 7, each of the capacitive electrodes 71 partially has a notched portion 190.

Here, the capacitive values of the storage capacitors 70 may be adjusted by increasing or decreasing the area of the capacitive electrodes 71. If the capacitive values of the storage capacitors 70 are small, since a time for holding the image signals is short, the quality of the display image is not substantially improved. Meanwhile, if the capacitive values of the storage capacitors 70 are large, since the image signals can be held for a long period of time, the improvement in the quality of the display image can be expected, but the supply circuits of the image signals or the lines may be enlarged. To this end, in an actual liquid crystal device, the capacitive values of the storage capacitors 70 need to be adjusted to adequate values.

In the present embodiment, the capacitive electrodes 71 each having the shape shown in FIG. 6 is formed by solidly forming a conductive layer on the second interlayer insulating film 15 and performing patterning so as to remove the conductive layer in the region close to the scanning lines 11 and the data lines 6. That is, the capacitive electrodes 71 are patterned in the shape shown in FIG. 6 in order to adequately adjust the capacitive values of the storage capacitors 70.

In a region (see FIG. 6), in which each of the capacitive electrodes 71 is not formed, of the image display region 10a, a planarization insulating film 19 which is an example of a “step difference reduction film” of the invention is formed on the same layer of the capacitive electrodes 71. In the present embodiment, in particular, the planarization insulating film 19 is formed such that the upper surfaces of the capacitive electrodes 71 and the planarization insulating film 19 are flush with each other. A planarization process such as Chemical Mechanical Polishing (CMP) process is performed such that the upper surfaces the capacitive electrodes 71 and the planarization insulating film 19 are flush with each other.

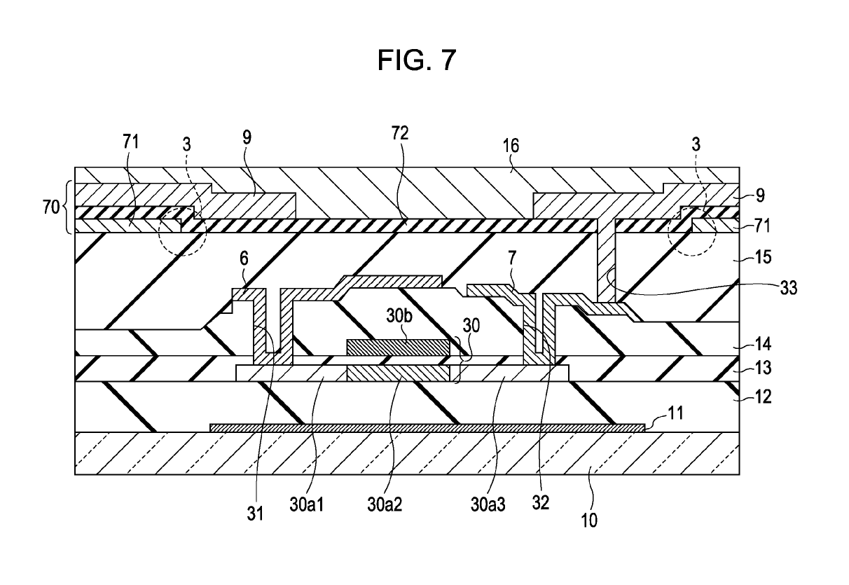

FIG. 7 is a cross-sectional view having the same purpose of FIG. 5 in a comparative example without the planarization insulating film 19. In the comparative example, since the planarization insulating film 19 (see FIG. 5) is not present, step difference portions 3 are formed between the upper surfaces of the capacitive electrodes 71 and the upper surface of the second interlayer insulating film 15 (a portion surrounded by a dotted line in FIG. 7). To this end, step differences are formed in the surfaces of the capacitive insulating films 72 solidly formed on the step difference portions 3 and the pixel electrodes 9 due to the step difference portions 3.

Although the step differences are reduced by forming the planarization insulating film 19 in the present embodiment (that is, the planarization insulating film 19 and the second interlayer insulating film 15 are formed as respective components), the planarization insulating film 19 and the second interlayer insulating film 15 may be integrally formed. That is, the upper surface of the second interlayer insulating film 15 may be formed to have a convex step difference in the region in which the capacitive electrodes 71 are not formed (that is, a lower electrode non-forming region of the invention).

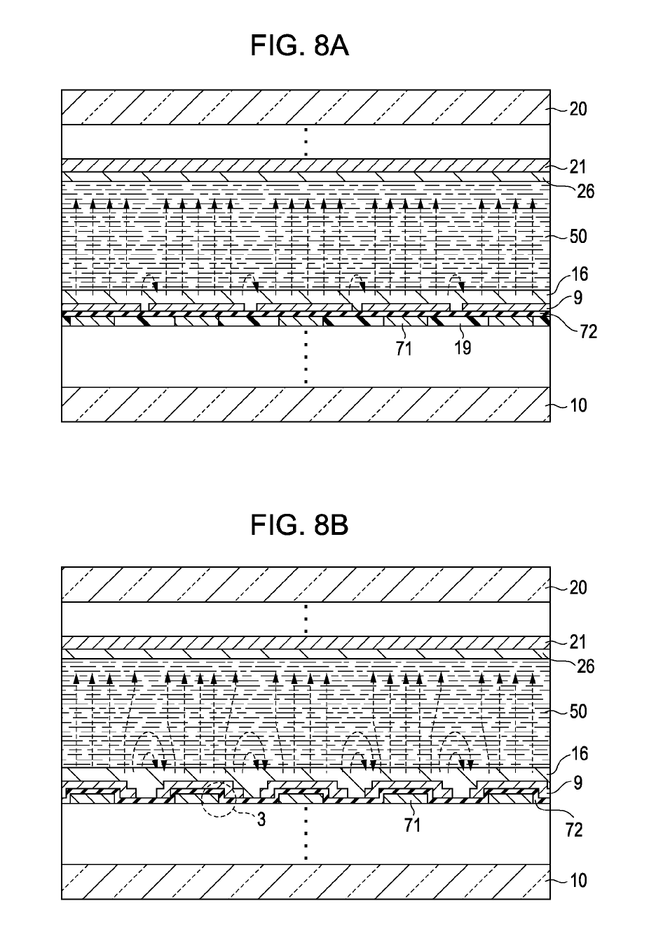

Next, the distribution of an electric field between the substrates (that is, the TFT array substrate 10 and the counter substrate 20) in the liquid crystal devices according to the present embodiment and the comparative examples will be described. FIGS. 8A and 8B are schematic cross-sectional views of the distribution of the electric field in a state of operating the liquid crystal device in the present embodiment and the comparative example.

As shown in FIG. 8A, in the liquid crystal device according to the present embodiment, by forming the planarization insulating film 19, the upper surfaces of the capacitive electrodes 71 and the planarization insulating film 19 are flush with each other. To this end, the step difference portions are not formed in the surfaces of the capacitive insulating film 72 formed at the upper layer side of the capacitive electrodes 71 and the planarization insulating film 19, and the pixel electrodes. As a result, in order to relatively uniformly generate the electric field (denoted by a dotted arrow in FIG. 8A) distributed between the pixel electrodes and the counter electrode 21 formed on the counter substrate 20 in a direction from the TFT array substrate 10 to the counter substrate 20, the alignment state of the liquid crystal molecules included in the liquid crystal layer 50 is normally controlled according to the image signals applied to the pixel electrodes. Since the smoothness of the surfaces of the pixel electrodes 9 are not damaged, it is possible to form a good alignment film which is hardly peeled or damaged. As a result, it is possible to realize a liquid crystal device capable of performing a higher-quality image display.

Meanwhile, as shown in FIG. 8B, the liquid crystal device according to the comparative example, since the planarization insulating film 19 is not formed, the step difference portions 3 are generated and the step differences are formed even in the surfaces of the capacitive insulating film 72 formed on the capacitive electrodes 71 and the pixel electrodes. To this end, the electric field distributed between the pixel electrodes and the counter electrode 21 formed on the counter substrate 20 is disturbed in the vicinities of the ends of the pixel electrodes 9. As a result, failure occurs in the alignment state of the liquid crystal molecules included in the liquid crystal layer 50 and the quality of the liquid crystal device deteriorates. In addition, the comparative example, since the smoothness of the surfaces of the pixel electrodes 9 are damaged, the alignment film 16 formed on the surfaces thereof is easily peeled or damaged, and risk in which alignment failure of an electro-optical material occurs is increased.

In the liquid crystal device according to the present embodiment, by forming the planarization insulating film 19 so as to prevent step differences from being generated in the surfaces of the pixel electrodes 9, it is possible to suppress alignment failure of the liquid crystal molecules of the liquid crystal layer 50 and to realize a high-quality image display.

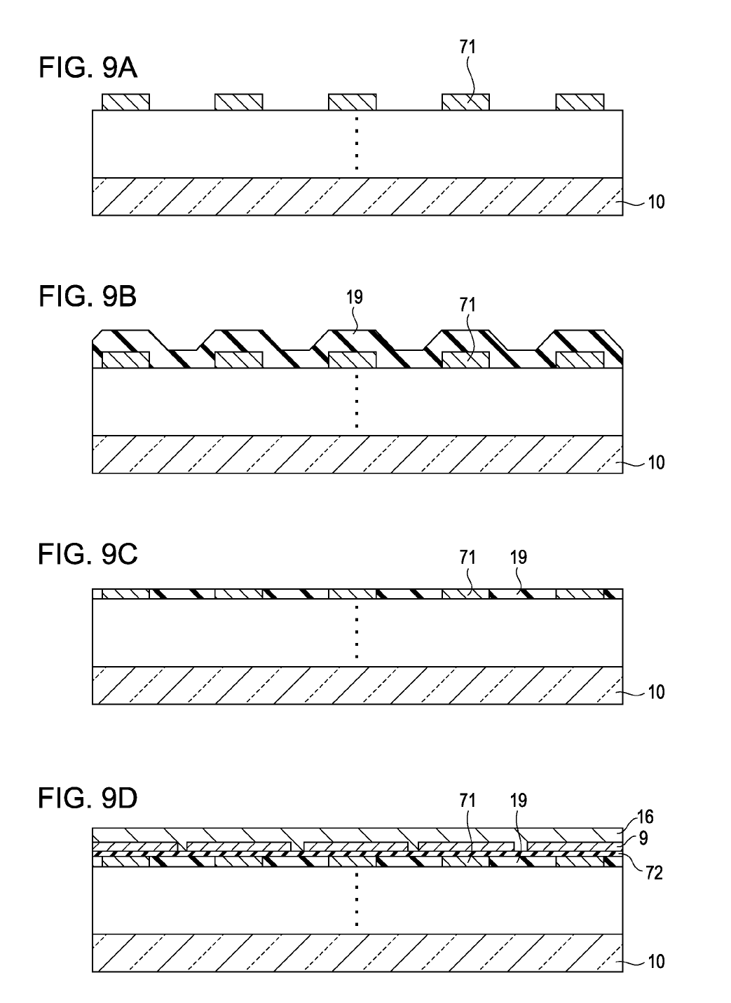

The lamination structure on the TFT array substrate 10 having the above-described planarization insulating film 19 may be formed by the following process. FIG. 9A to 9D are cross-sectional views of methods of forming the lamination structure on the TFT array substrate 10. Here, the process of forming the planarization insulating film 19 included in the above-described liquid crystal device will be mainly described and the description of the process of forming the other components will be properly omitted.

First, as shown in FIG. 9A, the conductive layer solidly formed on the TFT array substrate 10 is patterned so as to form the capacitive electrodes 71. An insulating film 19′ is formed on the capacitive electrodes 71 and the underlying layer so as to cover the capacitive electrodes 71 as shown in FIG. 9B.

Next, on the capacitive electrodes 71 and the insulating film 19′, a planarization process is performed over the whole of the TFT array substrate 10. In detail, by performing an etching process with respect to the capacitive electrodes 71 and the insulating film 19′, the surfaces of the capacitive electrodes 71 and the insulating film 19′ are removed so as to be flush with each other. As a result, as shown in FIG. 9C, the planarization insulating film 19 flush with the capacitive electrodes can be formed in the gaps between the adjacent capacitive electrodes 71. The capacitive insulating film 72, the pixel electrodes 9 and the alignment film 16 are formed at the upper layer side of the capacitive electrodes 71 and the planarization insulating film 19 (see FIG. 9D) such that the lamination structure on the TFT array substrate 10 is completed.

The completed substrate is adhered to the counter substrate 20 on which the counter electrode 21, the alignment film and the like are laminated with the seal material interposed therebetween and the liquid crystal 50 is filled therebetween, thereby completing the above-described liquid crystal device.

### Second Embodiment

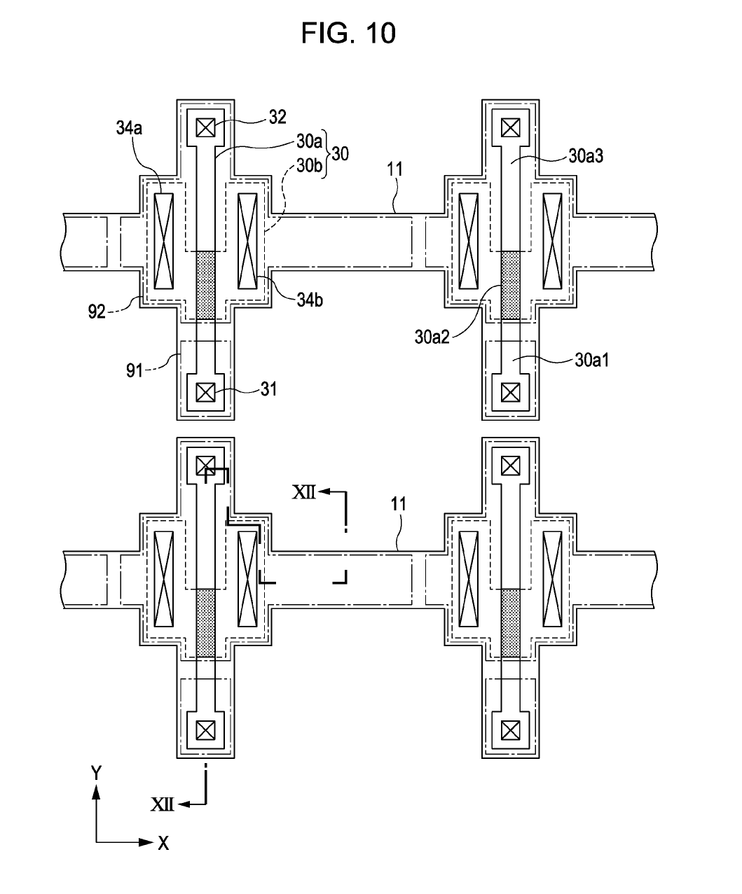

Next, a liquid crystal device according to a second embodiment will be described with reference to FIGS. 10 to 12. The second embodiment is different from the first embodiment in some configurations and is similar in the other configurations. To this end, in the second embodiment, portions different from those of the first embodiment will be described in detail and the description of the overlapping portions will be properly omitted.

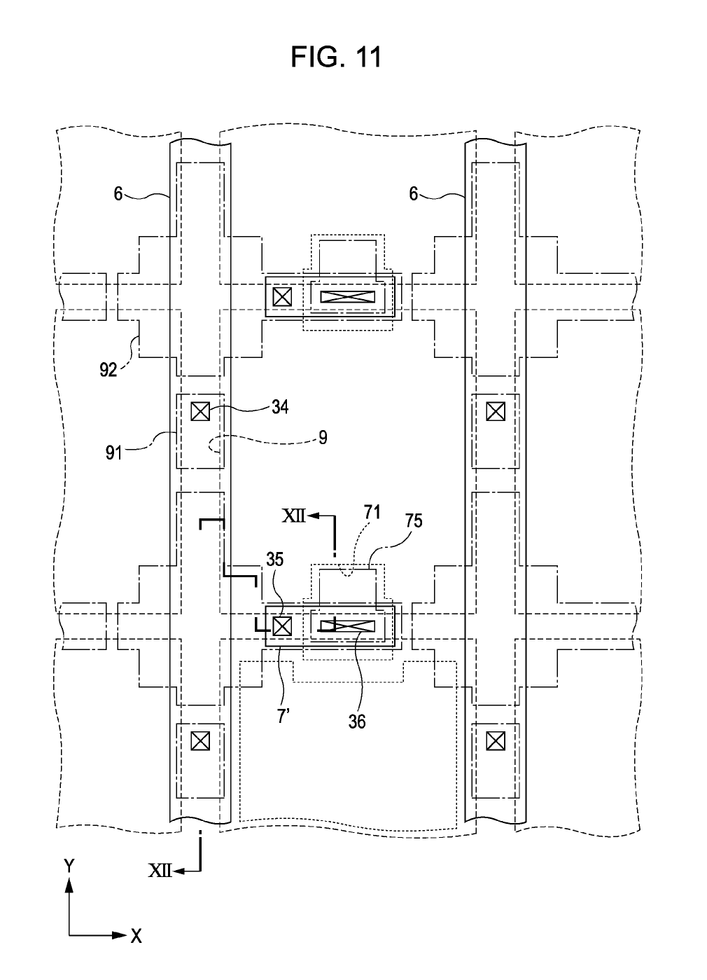

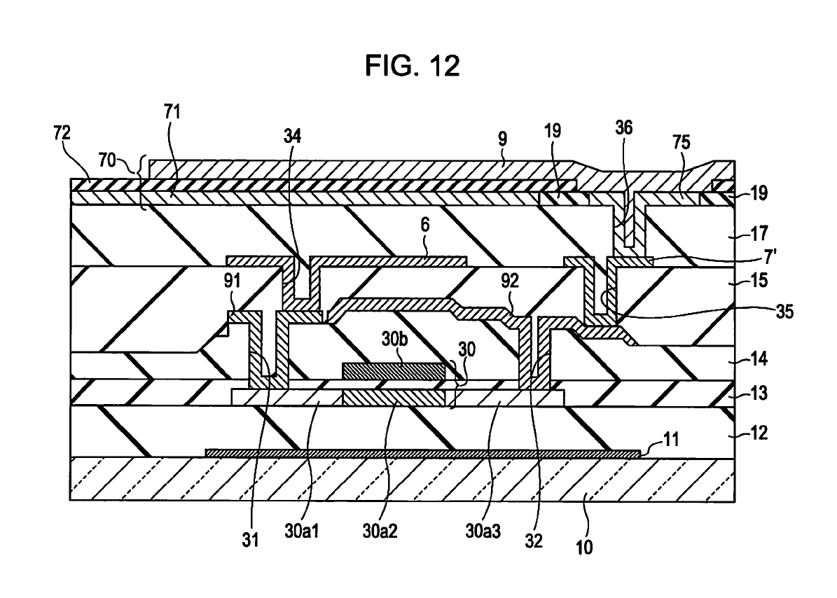

FIGS. 10 and 11 are plan views projectively showing the positional relationship between the layers configuring the liquid crystal device according to the second embodiment. FIG. 12 is a cross-sectional view showing a lamination structure of the liquid crystal device according to the second embodiment. In addition, the layers of the lower layer side of a fourth relay layer 91 and a third relay layer 92 are shown in FIG. 10 and the layers of the upper layer side of the fourth relay layer 91 and the third relay layer 92 are shown in FIG. 11. In FIGS. 10, 11 and 12, the scale of each layer or each element is differentiated from each other in order that each layer or each element has a size capable of being identified in the view. FIG. 12 is a cross-sectional view taken along line XII-XII′ of FIGS. 10 and 11, but a portion which does not completely correspond to line XII-XII′ is present, because the scale of each layer or each element is differentiated from each other as described above.

In FIGS. 10 and 12, the scanning lines 11 are disposed on the TFT array substrate 10 along the X direction and the TFTs 30 having the semiconductor layer 30a and the gate electrode 30b are disposed on the upper layer of the scanning lines 11 with the underlying insulating film 12 interposed therebetween.

The scanning lines 11 are formed of a light-shielding conductive material, for example, tungsten (W), titanium (Ti), titanium nitride (TiN), or the like, and include the semiconductor layer 30a on the TFT array substrate 10 in plan view. In detail, as shown in FIG. 10, a protrusion provided to protrude along the semiconductor layer 30a in the Y direction is included. Since the scanning lines 11 are disposed at the lower layer side of the semiconductor layer 30a, by including the above-described protrusion, it is possible to mostly or completely shield a channel region 30b of each of the TFTs 30 from return light such as light emitted from another liquid crystal device and penetrating a synthesis optical system by rear surface reflection of the TFT array substrate 10, a double plate type projector or the like. As a result, during the operation of the liquid crystal device, light leakage current of the TFTs 30 is reduced, a contrast ratio can be improved, and a high-quality image display is possible.

The semiconductor layer 30a includes the source region 30a1, the channel region 30a2 and the drain region 30a3. The Lightly Doped Drain (LDD) region may be formed between the channel region 30a2 and the source region 30a1 or between the channel region 30a2 and the drain region 30a3.

The gate electrode 30b is formed on the TFT array substrate 10 at an upper layer side of the semiconductor layer 30a in a region overlapping the channel region 30a2 of the semiconductor layer 30a with a gate insulating film 13 interposed therebetween in plan view. The gate electrode 30b is formed of, for example, conductive polysilicon and is electrically connected to each of the scanning lines 11 disposed at the lower layer side thereof via contact holes 34a and 34b.

The source region 30a1 of each of the TFTs 30 is electrically connected to the fourth relay layer 91 formed on the first interlayer insulating film 14 via a contact hole 31. Meanwhile, the drain region 30a3 is electrically connected to the third relay layer 92 formed on the same layer as the fourth relay layer 91 via a contact hole 32.

In FIGS. 11 and 12, the fourth relay layer 91 is electrically connected to the data lines 6 formed on the second interlayer insulating film 15 via a contact hole 34. Meanwhile, the third relay layer 92 is electrically connected to a second relay layer 7′ formed on the same layer as the data lines 6 via the contract hole 34. The second relay layer 7′ is further electrically connected to a first relay layer 75 provided on the same layer as the below-described capacitive electrodes 71 via a contact hole 36. The first relay layer 75 is electrically connected to the pixel electrodes 9. That is, the drain regions 30a3 of the TFTs 30 and the pixel electrodes 9 are electrically relayed and connected via the third relay layer 92, the second relay layer 7′ and the first relay layer 75 in this order.

A third interlayer insulating film 17 is formed at an upper layer side of the data lines 6 and the second relay layer 7′ and the storage capacitors 70 are formed thereon. As described above, by electrically connecting the storage capacitors 70 to the liquid crystal capacitors in parallel, the voltage of the pixel electrodes 9 can be maintained during the time longer than the time, in which the image signals are actually applied, for example, by three digits, and thus the holding characteristics of a liquid crystal element is improved. Therefore, it is possible to realize a liquid crystal device having a high contrast ratio.

The capacitive electrodes 71 formed on the third interlayer insulating film 17 function as one electrode of the storage capacitors 70 electrically connected to the liquid crystal capacitors in parallel and are electrically connected to the capacitive lines 300 so as to be held at a fixed potential. The capacitive electrodes 71 are formed of, for example, a transparent electrode such as ITO. To this end, even when the capacitive electrodes 71 are formed so as to overlap with the image display region 10a including an opened region, light transmissivity of the opened region does not substantially or practically deteriorate.

The capacitive electrodes 71 have openings formed over two adjacent pixels so as to surround the first relay layer 75 formed in the island shape. Portions in which portions excluding the openings of the capacitive electrodes 71 and the pixel electrodes 9 face each other configure the storage capacitors 70. The capacitive values of the storage capacitors 70 may be adjusted by increasing or decreasing the area of the opening of the capacitive electrodes 71. If the capacitive values of the storage capacitors 70 are small, since a time for holding the image signals is short, the quality of the display image is not substantially improved. Meanwhile, if the capacitive values of the storage capacitors 70 are large, since the image signals can be held for a long period of time, the improvement in the quality of the display image can be expected, but the supply circuits of the image signals or the lines may be enlarged. To this end, in an actual liquid crystal device, the capacitive values of the storage capacitors 70 need to be adjusted to adequate values.

The first relay layer 75 is formed at the inside of the openings of the capacitive electrodes 71 in plan view. The second relay layer 7′ is formed between the pixels at a position overlapping a portion where the scanning lines 11 extend, and the first relay layer 75 is formed in a shape elongated in a direction in which the data lines 6 extend from the second relay layer 7′. That is, the first relay layer 75 protrudes from a position connected to the second relay layer 7′ by the contact hole 36 toward the pixel electrodes 9. In addition, at this portion, the first relay layer 75 and the pixel electrodes 9 are connected. However, since the first relay layer 75 is formed of a transparent material, light transmissivity of the image display region 10a does not deteriorate even in portions overlapping the pixel electrodes.

The capacitive insulating film 72 is formed on the capacitive electrodes 71 as a dielectric film. The capacitive insulating film 72 is solidly formed so as to cover the capacitive electrodes 71, except that an opening is formed in a portion in which the first relay layer 75 is formed. In addition, since the capacitive insulating film 72 is formed of silicon nitride which is a transparent dielectric material, even when the capacitive insulating film 72 is widely formed in the image display region 10a including an opened region, light transmissivity of the opened region does not substantially or practically deteriorate.

The pixel electrodes 9 are formed on the capacitive insulating film 72. As shown in FIG. 11, the pixel electrodes 9 are respectively formed in the pixels partitioned by the data lines 6 and the scanning lines 11 in a matrix in an island shape. In addition, although not shown, the alignment film 16 for regulating the alignment state of the liquid crystal molecules included in the liquid crystal layer 50 (see FIG. 2) is formed on the pixel electrodes 9.

In the present embodiment, in particular, each of the pixel electrodes 9 has a function as one electrode of each of the storage capacitors 70, in addition to an original function for voltage-controlling the alignment state of the liquid crystal molecules configuring the liquid crystal layer 50. That is, by using the pixel electrodes 9 as the capacitive electrodes facing the capacitive electrodes 71, it is possible to simplify the lamination structure, as compared with the case where the capacitive electrodes facing the capacitive electrodes 71 are provided on the capacitive insulating film 72 on a layer different from the pixel electrodes 9 separately from the pixel electrodes 9. Accordingly, it is possible to obtain a merit that high definition of a pixel size is facilitated.

In the present embodiment, in a region (see FIG. 12), in which the capacitive electrodes 71 and the first relay layer 75 on the third interlayer insulating film 17 are not formed, a planarization insulating film 19 which is an example of a “step difference reduction film” of the invention is formed. In the present embodiment, in particular, the planarization insulating film 19 is formed such that the upper surfaces of the capacitive electrodes 71 and the planarization insulating film 19 are flush with each other. In detail, the planarization insulating film 19 is formed after forming the capacitive electrodes 71, a Chemical Mechanical Polishing (CMP) process is performed, and then planarization is performed by etch-back.

Although the step differences are reduced by forming the planarization insulating film 19 in the present embodiment (that is, the planarization insulating film 19 and the third interlayer insulating film 17 are formed as respective components), the planarization insulating film 19 and the third interlayer insulating film 17 may be integrally formed. That is, the upper surface of the third interlayer insulating film 17 may be formed to have a convex step difference in the region in which the capacitive electrodes 71 are not formed (that is, a lower electrode non-forming region of the invention).

In the liquid crystal device according to the present embodiment, by forming the planarization insulating film 19, the upper surfaces of the capacitive electrodes 71 and the planarization insulating film 19 are flush with each other. Since the capacitive insulating film 72 is thin, the flatness of the underlying layer in which the pixel electrodes are formed is increased. As a result, the electric field distributed between the pixel electrodes and the counter electrode 21 formed on the counter substrate 20 (see FIG. 2) is relatively uniformly generated in a direction from the TFT array substrate 10 to the counter substrate 20. To this end, the alignment state of the liquid crystal molecules included in the liquid crystal layer 50 is normally controlled according to the image signals applied to the pixel electrodes. Since the smoothness of the surfaces of the pixel electrodes 9 are not damaged, it is possible to form a good alignment film which is hardly peeled or damaged. As a result, it is possible to realize a liquid crystal device capable of performing a higher-quality image display.

As described above, in the liquid crystal device according to the second embodiment, similar to the first embodiment, by forming the planarization insulating film 19 so as to prevent step differences from being generated in the surfaces of the pixel electrodes 9. Therefore, it is possible to suppress alignment failure of the liquid crystal molecules of the liquid crystal layer 50 and to realize a high-quality image display.

### Electronic Apparatus

Next, the case where the liquid crystal device which is the above-described electro-optical device is applied to various electronic apparatuses will be described.

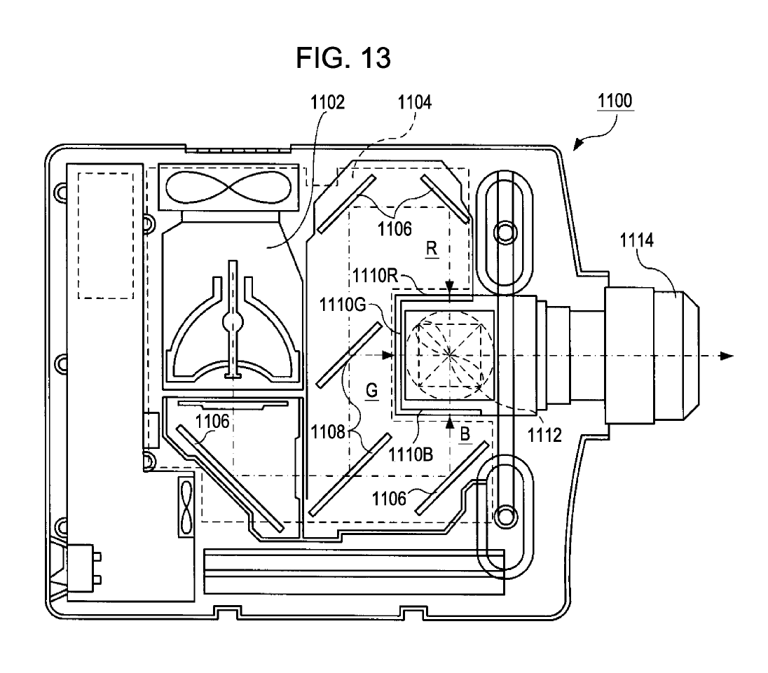

FIG. 13 is a plan view showing a configuration example of a projector. Hereinafter, a projector using this liquid crystal device as a light valve will be described.

As shown in FIG. 13, a lamp unit 1102 composed of a white light source such as a halogen lamp and the like is provided inside the projector 1100. An incident light emitted from the lamp unit 1102 is separated into three primary colors of R, G, and B by four mirrors 1106 and two dichroic mirrors 1108 disposed inside a light guide 1104 and the three primary colors are incident to liquid crystal panels 1110R, 1110B, and 1110G functioning as light valves corresponding to each of the primary colors.

The configurations of the liquid crystal panels 1110R, 1110B and 1110G are equal to that of the above-described liquid crystal device and are driven by the primary color signals of R, G and B supplied from an image signal processing circuit. The light modulated by such liquid crystal panel is incident into a dichroic prism 1112 from three directions. In the dichroic prism 1112, the light of R and B is refracted at an angle of 90 degrees and the light of G goes straight. Therefore, an image of each color is synthesized, whereby a color image is projected onto a screen or the like through a projector lens 1114.

Here, when attention is focused on a display image by each of the liquid crystal panels 1110R, 1110B, and 1110G, the display image by the liquid crystal panels 1110G needs to be mirror-inversed with respect to the display images by the liquid crystal panels 1110R and 1110B.

Further, since light corresponding to each of the primary colors R, G and B is incident to each of the liquid crystal panels 1110R, 1110B, and 1110G by the dichroic mirrors 1108, there is no need to provide a color filter.

In addition to the electronic apparatus described in FIG. 13, there are a mobile personal computer, a cellular phone, a liquid crystal television set, a viewfinder-type or direct-view monitor type video tape recorder, a car navigation system, a pager, an electronic organizer, an electronic calculator, a word processor, a workstation, a videophone, a POS terminal, and a touch-panel-equipped device. The above-described electronic apparatus can be implemented as a display unit of such exemplary electronic devices.

In addition, the invention may also be applied to a reflective liquid crystal device (LCOS), a plasma display panel (PDP), a field emission type display (FED, SED), an organic EL display, a digital micromirror device (DMD), an electrophoresis device, and the like, in addition to the liquid crystal device described in the above-mentioned embodiments.

The invention is not limited to the above-described embodiments and may be properly modified without departing from the scope or spirit of the invention which can be read from claims and the specification. An electro-optical device including such modification and an electronic apparatus including the electro-optical device are included in the technical range of the invention.

The entire disclosure of Japanese Patent Application Nos: 2009-012679, filed Jan. 23, 2009, 2009-263650, filed Nov. 19, 2009 are expressly incorporated by reference herein.

What is claimed is:

1. An electro-optical device comprising:
a plurality of pixel electrodes arranged in a pixel region;
a lower electrode disposed at a lower layer side of the plurality of pixel electrodes with a dielectric film interposed therebetween so as to at least partially overlap the plurality of pixel electrodes in plan view; and
a step difference reduction film disposed on an underlying surface of the lower electrode, the step difference reduction film being formed in at least a portion of a lower electrode non-forming region of the pixel region so as to reduce a step difference between the upper surfaces of the lower electrode and the underlying surface in the lower electrode non-forming region.

2. The electro-optical device according to claim 1, wherein the upper surfaces of the lower electrode and the step difference reduction film are flush with each other.

3. The electro-optical device according to claim 1, wherein the upper surfaces of the lower electrode and the step difference reduction film are subjected to a planarization process for reducing the step difference therebetween.

4. The electro-optical device according to claim 1, wherein the plurality of pixel electrodes and the lower electrode are formed of a transparent conductive material.

5. An electro-optical device comprising:
transistors;
pixel electrodes provided in correspondence with the transistors;
a lower electrode disposed on a layer between the transistors and the pixel electrodes and facing the pixel electrodes with a dielectric film interposed therebetween so as to form storage capacitors;
a first relay layer disposed on the same layer as the lower electrode on the inside of an opening of the lower electrode and electrically connecting the transistors and the pixel electrodes in plan view; and
a step difference reduction film disposed between the lower electrode and the first relay layer in plan view.

6. The electro-optical device according to claim 5, wherein the pixel electrodes, the lower electrode and the first relay layer are formed of a transparent conductive material.

7. The electro-optical device according to claim 5, comprising:
data lines disposed on a layer between the transistors and the lower electrode and electrically connected to the transistors; and
a second relay layer disposed on the same layer as the data lines and electrically connecting the transistors and the pixel electrodes,
wherein the first relay layer and the second relay layer are electrically connected via contact holes provided in the openings in plan view.

8. The electro-optical device according to claim 5, wherein the first relay layer is long in a length of a direction in which the data lines extend from the second relay layer.

9. The electro-optical device according to claim 5, wherein the surfaces of the lower electrode, the first relay layer and the step difference reduction film are smoothly flush with one another.

10. An electronic apparatus comprising:
an electro-optical device including:
a plurality of pixel electrodes arranged in a pixel region;
a lower electrode disposed at a lower layer side of the plurality of pixel electrodes with a dielectric film interposed therebetween so as to at least partially overlap the plurality of pixel electrodes in plan view; and
a step difference reduction film disposed on an underlying surface of the lower electrode, the step difference reduction film being formed in at least a portion of a lower electrode non-forming region of the pixel region so as to reduce a step difference between the upper surfaces of the lower electrode and the underlying surface in the lower electrode non-forming region.

11. The electronic apparatus according to claim 10, wherein the upper surfaces of the lower electrode and the step difference reduction film are flush with each other.

12. The electronic apparatus according to claim 10, wherein the upper surfaces of the lower electrode and the step difference reduction film are subjected to a planarization process for reducing the step difference therebetween.

13. The electronic apparatus according to claim 10, wherein the plurality of pixel electrodes and the lower electrode are formed of a transparent conductive material.

14. An electronic apparatus comprising:
an electro-optical device including:
transistors;
pixel electrodes provided in correspondence with the transistors;
a lower electrode disposed on a layer between the transistors and the pixel electrodes and facing the pixel electrodes with a dielectric film interposed therebetween so as to form storage capacitors;
a first relay layer disposed on the same layer as the lower electrode on the inside of an opening of the lower electrode and electrically connecting the transistors and the pixel electrodes in plan view; and
a step difference reduction film disposed between the lower electrode and the first relay layer in plan view.

15. The electronic apparatus according to claim 14, wherein the pixel electrodes, the lower electrode and the first relay layer are formed of a transparent conductive material.

16. The electronic apparatus according to claim 14, wherein the electro-optical device further includes:
data lines disposed on a layer between the transistors and the lower electrode and electrically connected to the transistors; and
a second relay layer disposed on the same layer as the data lines and electrically connecting the transistors and the pixel electrodes,
wherein the first relay layer and the second relay layer are electrically connected via contact holes provided in the openings in plan view.

17. The electronic apparatus according to claim 14, wherein the first relay layer is long in a length of a direction in which the data lines extend from the second relay layer.

18. The electronic apparatus according to claim 14, wherein the surfaces of the lower electrode, the first relay layer and the step difference reduction film are smoothly flush with one another.
